(19) United States
(12) Patent Application Publication
(10) Pub. No.: US 2022/0206123 A1
(43) Pub. Date: Jun. 30, 2022

(54) LIGHT SCANNING DEVICE AND DISTANCE MEASURING DEVICE

(71) Applicants: Kensuke YAMADA, Tokyo (JP); Takahiko NISHIYAMA, Tokyo (JP); Toyoki TANAKA, Tokyo (JP); Yuji KIMURA, Tokyo (JP)

(72) Inventors: Kensuke YAMADA, Tokyo (JP); Takahiko NISHIYAMA, Tokyo (JP); Toyoki TANAKA, Tokyo (JP); Yuji KIMURA, Tokyo (JP)

(73) Assignee: MITSUMI ELECTRIC CO., LTD., Tokyo (JP)

(21) Appl. No.: 17/644,602

(22) Filed: Dec. 16, 2021

(30) Foreign Application Priority Data
Dec. 28, 2020 (JP) 2020-218902

(51) Int. Cl. G01S 7/481; G01B 21/22; G01S 17/08

(52) U.S. Cl. CPC G01S 7/4817; G01S 17/08; G01B 21/22

(57) ABSTRACT

A light scanning device includes a light emitter configured to emit light; an optical scanner configured to cause the light to scan; a light receiver configured to receive returning light as scanning light from the optical scanner being reflected or scattered on an object; and an optical scanning controller including processing circuitry configured to control the optical scanner. The optical scanner includes a rotating polyhedron configured to include a plurality of reflective surfaces, to cause the light to scan around a first axis by reflecting the light on a reflective surface while rotating around the first axis; a supporter configured to support the rotating polyhedron; and a rotating mechanism configured to rotate the supporter around a second axis that crosses the first axis, to cause the light reflected on the reflective surface to scan around the second axis.

### CROSS-REFERENCE TO RELATED APPLICATIONS

The present application is based upon and claims priority under 35 U.S.C. § 119 to Japanese Patent Application No. 2020-218902 filed on Dec. 28, 2020, the entire contents of which are incorporated herein by reference.

### TECHNICAL FIELD

The present disclosure relates to a light scanning device and a distance measuring device.

### BACKGROUND ART

Conventionally, a light scanning device that causes a light emitter to emit light scanning an object, and receive returning light of the scanning light being reflected or scattered on the object.

Also, a configuration is disclosed that includes a movable part that is swingable around the first axis center; a first deflection mechanism provided with a driver that drives the movable part to swing; a second deflection mechanism that drives the first deflection mechanism to rotate around a second axis center that is different from the first axis center; a light deflector installed in the movable part to reflect and deflect measurement light emitted from a light projector/receiver along the second axis center; and a swing controller that controls the driver described above (see, for example, Patent Document 1).

### RELATED ART DOCUMENTS

### Patent Documents

### [Patent Document 1] Japanese Patent No. 6069628

However, the configuration in Patent Document 1 needs to control the swing of the movable part, and hence, the control may become complicated.

### SUMMARY

According to one aspect in the present disclosure, a light scanning device includes a light emitter configured to emit light; an optical scanner configured to cause the light to scan; a light receiver configured to receive returning light as scanning light from the optical scanner being reflected or scattered on an object; and an optical scanning controller including processing circuitry configured to control the optical scanner. The optical scanner includes a rotating polyhedron configured to include a plurality of reflective surfaces, to cause the light to scan around a first axis by reflecting the light on a reflective surface while rotating around the first axis; a supporter configured to support the rotating polyhedron; and a rotating mechanism configured to rotate the supporter around a second axis that crosses the first axis, to cause the light reflected on the reflective surface to scan around the second axis.

### BRIEF DESCRIPTION OF DRAWINGS

FIG. 1 is a perspective view illustrating an example of an overall configuration of a distance measuring device according to an embodiment;

FIG. 2 is a partially enlarged perspective view illustrating an example of a configuration in the vicinity of an LD and an APD in FIG. 1;

FIG. 3 is a partially enlarged perspective view illustrating an example of a configuration in the vicinity of a polygon mirror in FIG. 1;

FIG. 4 is a block diagram illustrating an example of an overall configuration of a distance measuring device according to an embodiment;

FIG. 5 is a block diagram of an example a functional configuration of a controller held in a distance measuring device according to an embodiment;

FIG. 6 is a flowchart illustrating an example of operations executed by a distance measuring device according to an embodiment;

FIGS. 7A and 7B are diagrams illustrating examples of optical scanning executed by a distance measuring device according to an embodiment, where FIG. 7A is a side view of the distance measuring device; and FIG. 7B is a top view of the distance measuring device;

FIG. 8 is a diagram illustrating examples of trajectories of scanning lines;

FIGS. 9A and 9B illustrate other examples of trajectories of scanning lines, wherein FIG. 9A illustrates a comparative example, and FIG. 9B illustrates an embodiment;

FIG. 10 is a diagram illustrating a first example of the inter-axes distance between the first axis and the second axis;

FIG. 11 is a diagram illustrating a second example of the inter-axes distance between the first axis and the second axis; and

FIG. 12 is a diagram illustrating a third example of the inter-axes distance between the first axis and the second axis.

### EMBODIMENTS OF THE INVENTION

In the following, embodiments for carrying out the inventive concept will be described with reference to the accompanying drawings.

Note that throughout the drawings, for elements having substantially the same configurations, the same reference signs are assigned, and duplicate descriptions may be omitted.

According to the present inventive concept, a light scanning device in which the control can be simplified, can be provided.

Also, the embodiments described hereafter exemplify a light scanning device and a distance measuring device for carrying out the technical concepts in the present disclosure, and are not intended to limit the present inventive concept to the embodiments described hereafter. The dimensions, materials, shapes, relative layouts, and the like, of the constituent parts described below are not intended to limit the scope of the present inventive concept to those described, but are intended to be exemplary unless otherwise specified. Also, the size and positional relationship of the members illustrated in the drawings may be exaggerated to clarify the description.

A light scanning device according to an embodiment includes a light emitter configured to emit light; an optical scanner configured to cause the light to scan; a light receiver configured to receive returning light of scanning light from the optical scanner, being reflected or scattered on an object; and an optical scanning controller configured to control the optical scanner.

Such a light scanning device is installed in a distance measuring device or the like that measures a distance to an object based on returning light being reflected or scattered on the object, and is used for projecting scanning light to the side on which an object is present. Note that the distance to the object can also be rephrased as the distance between the object and the distance measuring device.

Here, for example, when the optical scanner includes an element in which a movable part having a reflective surface is swinging back and forth to scan the light, the control may become complicated with respect to control of suppressing fluctuation of the swing rate of the movable part, and control of the resonant frequency of the movable part, and the like.

In an embodiment, the optical scanner includes a rotating polyhedron that includes multiple reflective surfaces, and causes light to scan around the first axis by reflecting the light emitted by the light emitter on the reflective surface while rotating around the first axis. Also, the optical scanner includes a supporter configured to support the rotating polyhedron, and a rotating mechanism configured to cause the light reflected on the reflective surface of the rotating polyhedron to scan around the second axis by rotating the supporter around the second axis.

For example, the rotating polyhedron is a polygon mirror. Also, the rotating mechanism is a rotating stage that is rotatable while bearing the polygon mirror and the supporter. The rotating polyhedron and the rotating mechanism rotate continuously in a predetermined direction of rotation; therefore, it is not necessary to execute control of suppressing fluctuation of the swing rate of a movable part, control of the resonant frequency, and the like. In this way, a light scanning device in which the control can be simplified, can be provided.

In the following, an embodiment will be described taking as an example a light scanning device that is provided in a distance measuring device installed in a service robot, where the distance measuring device is capable of measuring the distance to an object present in the traveling direction of the service robot or present around the service robot.

Here, the service robot means an autonomously mobile body primarily used for the purpose of services such as transportation of materials in a factory, transportation of merchandise and information services in a customer service facility, on-site security, cleaning, and the like. Also, the mobile body means an object that is movable.

The distance measuring device installed in the service robot is used for detecting an object in the traveling direction of the service robot or around the service robot, or creating an in-house map of a facility where the service robot is operating. Also, the distance measuring device is, for example, a LiDAR (Light Detection and Ranging, or Laser Imaging Detection and Ranging) device.

Note that in the drawings shown below, in the case of indicating the directions of the X-axis, the Y axis, and the Z-axis, the X-direction along the X-axis indicates a direction along the first axis as the axis of rotation of the polygon mirror provided in the distance measuring device according to an embodiment. The Z-direction along the Z-axis indicates a direction along the second axis as the axis of rotation of the rotating stage provided in the distance measuring device according to an embodiment. The X-axis crosses the Z-axis. The Y-direction along the Y-axis indicates a direction crossing both the X-axis and the Z-axis.

Also, a direction in which the arrow points in the X direction is denoted as the +X direction, and a direction opposite to the direction in which the arrow points in the +X direction is denoted as the −X direction; a direction in which the arrow points in the Y direction is denoted as the +Y direction, and a direction opposite to the direction in which the arrow points in the +Y direction is denoted as the −Y direction; a direction in which the arrow points in the Z direction is denoted as the +Z direction, and a direction opposite to the direction in which the arrow points in the +Z direction is denoted as the −Z direction. However, these do not restrict the directions during use of the distance measuring device and the light scanning device; the distance measuring device and the light scanning device can be oriented in any directions.

### <Example of Configuration of Distance Measuring Device 100>

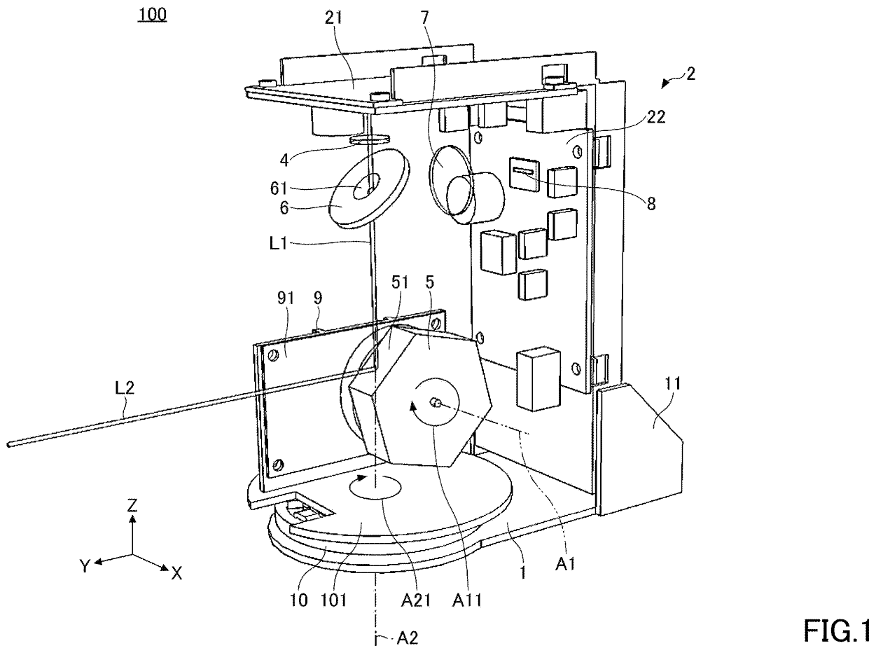

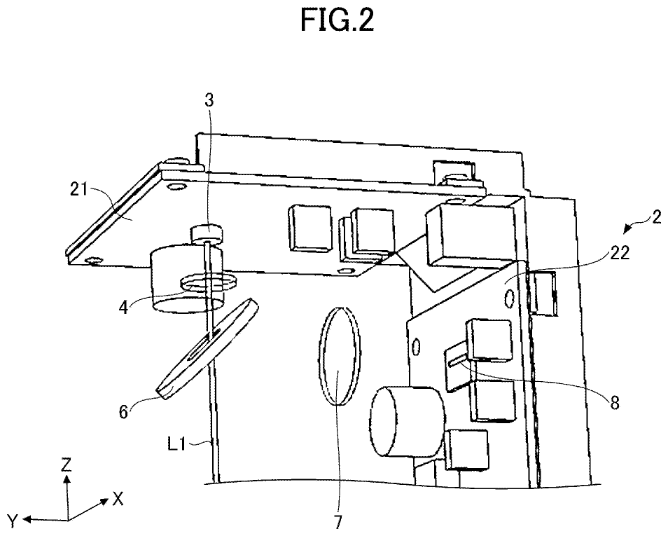

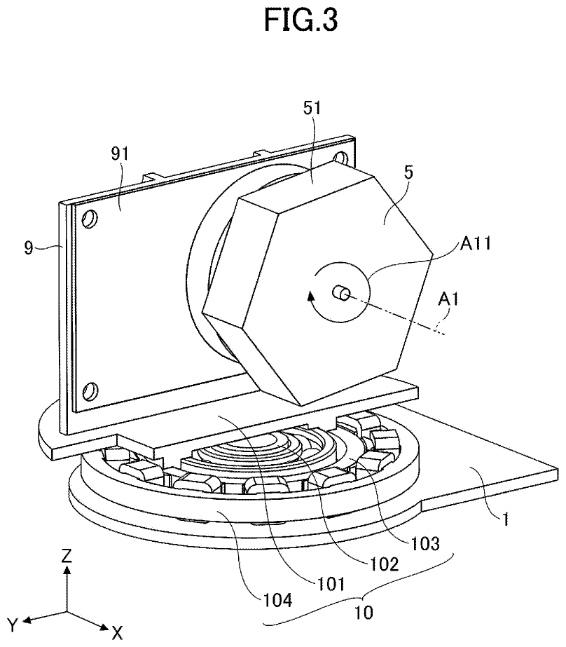

First, with reference to FIGS. 1 to 3, an example of an overall configuration of a distance measuring device 100 according to an embodiment will be described. FIG. 1 is a perspective view illustrating an example of the overall configuration of the distance measuring device 100. Also, FIG. 2 is a partially enlarged perspective view illustrating an example of a configuration in the vicinity of an LD and an APD. FIG. 3 is a partially enlarged perspective view illustrating an example of a configuration in the vicinity of a polygon mirror.

As illustrated in FIGS. 1 to 3, the distance measuring device 100 includes a base plate 1, a holder 2, an LD (Laser Diode) 3 (see FIG. 2), a collimating lens 4, a polygon mirror 5, a holed mirror 6, a light receiving lens 7, an APD (Avalanche Photodiode) 8, an angle plate 9, and a rotating stage 10.

The base plate 1 is an example of a base provided with the holder 2 and the rotating stage 10. Note that although the base is exemplified as a flat plate-like member such as the base plate 1, it is not limited as such; the base may be any element as long as the rotating stage 10 and the holder 2 can be provided. For example, in the case of providing the holder 2 and the rotating stage 10 in the housing of the service robot that will be described later, the housing of the service robot corresponds to the base.

The base plate 1 is a flat plate-like member, and has the holder 2 and the rotating stage 10 fixed at different areas on a face on the +Z direction side of the flat plate. More specifically, the base plate 1 has the rotating stage 10 fixed to an area on the +Y direction side of the base plate 1 with screws and the like, and has the holder 2 fixed to an area on the −Y direction of the rotating stage 10 with screws and the like via a binding member 11.

Although the material of the base plate 1 is not limited in particular, it is favorable to form the base plate 1 to include a rigid material such as a metal material, because in some cases, the rotating stage 10 is heavy.

The holder 2 is an inverted L-shaped member formed by combining a ceiling panel 21 and a rear panel 22. Each of the ceiling panel 21 and the rear panel 22 is a flat plate-like member, and the holder 2 is formed by combining the ceiling panel 21 and the rear panel 22. The material of the ceiling panel 21 and the rear panel 22 is not limited in particular; for example, a metal material or a resin material can be used.

On a surface of the ceiling panel 21 on the −Z direction side, the LD 3, the collimating lens 4, and the holed mirror 6 are fixed. On a surface of the rear panel 22 on the +Y direction side, the light receiving lens 7 and the APD 8 are fixed. The holder 2 holds the LD 3 to be fixed to the ceiling panel 21, and holds the APD 8 to be fixed to the rear panel 22.

The LD 3 is an example of a light emitter configured to emit light. The LD 3 is capable of emitting laser light on the ZN-axis direction side. However, the light emitter is not limited to the LD. As long as light can be emitted, a light emitter other than the LD such as an LED (light emitting diode) may be used.

The light emitted by the light emitter may be CW (Continuous Wave) light or may be pulsed light. Although the wavelength of light emitted by the light emitter is not limited in particular, it is more favorable to use laser light in a non-visible wavelength region such as a near infrared wavelength region, because distance measuring can be executed without having the laser light visually recognized by persons.

The collimating lens 4 is formed to include a glass material or a resins material, and substantially collimates (substantially parallelizes) beams of the laser light emitted by the LD 3. Although the collimating lens 4 is not necessarily provided, by providing the collimating lens 4, the spread of the laser light emitted by the LD 3 can be suppressed, and the light utilization efficiency can be improved.

Laser light L1 collimated in the collimating lens 4 passes through a through hole 61 of the holed mirror 6, to be incident on a reflective surface 51 of the polygon mirror 5.

The polygon mirror 5 is an example of a rotating polyhedron that includes multiple reflective surfaces 51, and causes scanning laser light L2 corresponding to the reflected light of the laser light L1 to scan around the first axis A1 by reflecting the laser light L1 on one of the reflective surface surface 51, while rotating around the first axis A1. Note that the reflective surface 51 is a generic term of the multiple reflective surfaces.

The polygon mirror 5 causes the light reflected by the reflective surface 51 to scan so as to draw part of a circle centered on the first axis A1, while being rotated. The light scanning around the first axis A1 is, in other words, light scanning along a circumferential direction of the circle around the first axis A1.

The polygon mirror 5 is a regular hexagonal cylinder-like member. Six reflective surface 51 are formed on the outward faces each corresponding to each side of the regular hexagon in the regular hexagonal cylinder. The polygon mirror 5 can be fabricated by cutting or mirror polishing the outward faces of a substantially regular hexagonal cylinder-like member formed of a metallic material such as aluminum. However, the fabrication is not limited as such; for example, the polygon mirror 5 may be fabricated by specular deposition of aluminum or the like on the outward faces of a substantially regular hexagonal cylinder-like member formed of a metallic material or a resin material.

Note that in FIG. 1, although the polygon mirror 5 is exemplified as having a regular hexagonal cylinder-like shape with six faces of the reflective surfaces 51, the rotating polyhedron is not limited as such. For example, the rotating polyhedron may be a rotating polyhedron having a regular triangular cylinder-like shape with three reflective surfaces, or may be a rotating polyhedron having a regular pentagonal cylinder-like shape with five reflective surfaces.

The scanning angle range of light by the rotating polyhedron varies depending on the number of faces of the rotating polyhedron. For example, a larger number of faces makes the scanning angle range narrower, whereas a smaller number of faces makes the scanning angle range wider. The number of faces of the rotating polyhedron can be determined properly depending on the required scanning angle range.

A first axis motor is attached to the polygon mirror 5, so that the central axis and the axis of rotation of the polygon mirror 5 are substantially coincident with each other. The polygon mirror 5 is rotated around the first axis A1 by the first axis motor as the driving source.

The direction of rotation of the polygon mirror 5 is predetermined; for example, the polygon mirror 5 is rotated continuously along the direction of first axis rotation A11 in FIG. 1. However, the polygon mirror 5 may be rotated continuously in a predetermined direction of rotation opposite to the direction of first axis rotation All.

The laser light L1 incident on the reflective surface 51 of the polygon mirror 5 is reflected on the reflective surface 51, and emitted on the +Y direction side. The rotation of the polygon mirror 5 continuously changes the angle of the reflective surface 51 with respect to the incident direction of the laser light L1, and thereby, the light reflected by the reflective surface 51 is caused to scan around the first axis A1, to be emitted on the +Y direction side as the scanning laser light L2.

Note that FIG. 1 exemplifies the scanning laser light L2 as one laser beam emitted on the +Y direction side at any timing, among beams of the scanning laser light L2 scanning around the first axis A1.

In the case where an object is present on the +Y direction side of the distance measuring device 100, returning light as the scanning laser light L2 being reflected or scattered on the object returns to the distance measuring device 100. The returning light is again incident on the reflective surface 51 of the polygon mirror 5, and is caused to scan around the first axis A1 by rotation of the polygon mirror 5. Among light beams of the returning light caused to scan, those beams reaching the holed mirror 6 is reflected on the −Y direction side by the holed mirror 6 to be deflected.

In the present embodiment, the reflective surface 51 of the polygon mirror 5 on which the laser light L1 is reflected is the same reflective surface 51 of the polygon mirror 5 on which the returning light light is reflected. The returning light reflected on the same reflective surface is received by the APD 8.

In other words, the scanning laser light L2 reflected on one of the multiple reflective surfaces 51 included in the polygon mirror 5, is reflected or scattered on the object, and then, the APD 8 receives the returning light reflected again on the one surface.

The holed mirror 6 is an example of a light deflector that deflects returning light as the scanning laser light L2 being reflected or scattered on an object. This holed mirror 6 includes the through hole 61. The through hole 61 is an example of an opening portion through which light emitted by the LD 3 passes, and is formed in part of the area where the reflective surface is provided in the holed mirror 6. Among light beams incident on the holed mirror 6, those light beams incident on the reflective surface are reflected, and the other light beams incident on the through hole 61 pass through.

Note that in the present embodiment, although a configuration is exemplified in which a light deflector includes a through hole as an opening portion, the configuration is not limited as such. Part of the area provided with the reflective surface in the light deflector may be formed to be transparent, and by causing light to transmit through the transparent area, so as have to part of the area area function as the opening portion. Also, a beam splitter, a half mirror, or the like can be used as the light deflector.

The laser light L1 collimated in the collimating lens 4 passes through a through hole 61 of the holed mirror 6, to be incident on a reflective surface 51 of the polygon mirror 5. Meanwhile, returning light as the scanning laser light L2 being reflected or scattered on the object is reflected toward the APD 8 by the reflective surface of the holed mirror 6.

Light reflected on the holed mirror 6 is incident on the APD 8 while being collected by the light receiving lens 7. Although the light receiving lens 7 is not necessarily provided, it is favorable to provide the light receiving lens 7 in terms of improving the incidence efficiency of the laser light incident on the APD 8.

The APD 8 is an example of a light receiver that receives returning light as the scanning laser light L2 being reflected or scattered on an object. The APD 8 is a type of photodiode whose light sensitivity is improved by using a phenomenon called avalanche breakdown. Note that although the light receiver is exemplified as an APD, it is not limited as such; a PD (Photodiode) other than an APD, a photomultiplier tube, or the like may be used.

The angle plate 9 is a member formed to have an L shape, and is an example of a supporter to support the polygon mirror 5. The angle plate 9 has its bottom surface (a surface on the −Z direction side) contact the placement surface 101 of the rotating stage 10, and is fixed on the placement surface 101 by screws and the like. Also, the angle plate 9 fixes the polygon mirror 5, via the board 91, on its front surface (a surface on the +X direction side) crossing to the bottom surface. Although the material of the angle plate 9 is not limited in particular, in order to secure high rigidity, it is favorable to be formed to include a highly rigid material such as metal.

The rotating stage 10 is an example of a rotating mechanism that causes the scanning laser light L2 reflected on the reflective surface 51 of the polygon mirror 5 fixed to the angle plate 9, to scan around the second axis A2, by rotating the angle plate 9 around the second axis A2.

The rotating stage 10 is provided on the base plate 1 in an area different from the area where the holder 2 is provided. Therefore, even when the rotating stage 10 rotates, the holder 2, and the LD 3 and APD 8 held by the holder 2 do no move, and the state of being fixed to the base plate 1 is maintained.

The rotating stage 10 causes light reflected by the reflective surface 51 of the polygon mirror 5 to scan, so as to draw part of a circle centered on the second axis A2, while being rotated. The light scanning around the second axis A2 is, in other words, light scanning along a circumferential direction of the circle around the second axis A2.

As illustrated in FIG. 3, the rotating stage 10 includes the placement surface 101, a bearing 102, a magnet 103, and a motor core 104.

The placement surface 101 is a surface rotatable around the second axis A2 (see FIG. 1). The placement surface 101 has the angle plate 9 placed. The bearing 102 is a member that smooths the rotation of the placement surface 101. Various types of bearings such as a ball bearing or a cross roller bearing can be used.

The magnet 103 is a permanent magnet. The motor core 104 is a member corresponding to an iron core of a stator that is a part of a motor. The motor is configured to include the magnet 103 and the motor core 104. The magnet 103 rotating in response to an electric current enables the placement surface 101 to rotate via the bearing 102.

The direction of rotation of the rotating stage 10 is predetermined. For example, the rotating stage 10 continuously rotates along the direction of the second axis rotation A21 in FIG. 1. However, the rotating stage 10 may continuously rotate in a predetermined direction of rotation opposite to the direction of the second axis rotation A21.

As illustrated in FIG. 1, the positions and angles of the LD 3, the collimating lens 4, and the rotating stage 10 are adjusted so as to cause the laser light L1 emitted by the LD 3 and collimated by the collimating lens 4 to be incident on the reflective surface 51 of the polygon mirror 5 along the second axis A2.

For example, the distance measuring device 100 is configured to have the optical axis of the laser light L1 coaxial with the second axis A2. Here, the optical axis of the laser light L1 means an axis passing through the center of the laser beams. Also, “coaxial” mean that multiple axes are substantially identical.

The scanning laser light L2 is caused to scan around the first axis A1 by rotation of the polygon mirror 5, and is also caused to scan around the second axis A2 by rotation of the rotating stage 10. The distance measuring device 100 can cause the laser light to scan around the crossing two axes.

Note that in the present embodiment, although a configuration is exemplified in which the first axis A1 is substantially orthogonal to the second axis A2, the configuration is not limited as such; the second axis A2 may be arranged to be inclined with respect to the first axis A1.

Also, in FIGS. 1 to 3, although a configuration is exemplified in which the distance measuring device 100 does not have an exterior cover, the distance measuring device 100 may be provided with an exterior cover to cover part of or all of the elements including the LD 3, the polygon mirror 5, the APD 8, the rotating stage 10, and the like.

By providing an exterior cover, it becomes possible to prevent dust, dirt, and the like from entering the interior of the distance measuring device 100, and to prevent dust, dirt, and the like from adhering to the polygon mirror 5. Also, when the polygon mirror 5 and the rotating stage 10 are rotated at a high speed, the noise accompanying the rotation may increase; in such a case, by providing an exterior cover, it becomes possible to prevent sound from being transmitted to the surroundings. As the material of the exterior cover, a metal or resin material or the like can be used.

Meanwhile, when the exterior cover is provided, part of the exterior cover other than the emission window from which the scanning laser light L2 is emitted, blocks the scanning laser light L2, and thereby, the scanning angle range may be limited, and the detection range or distance measurement range of an object 200 by the distance measuring device 100 may be limited. If forming the exterior cover of a transparent resin material that has optical transparency with respect to the wavelength of the scanning laser light L2, such a limitation of the scanning angle range can be alleviated, which is favorable.

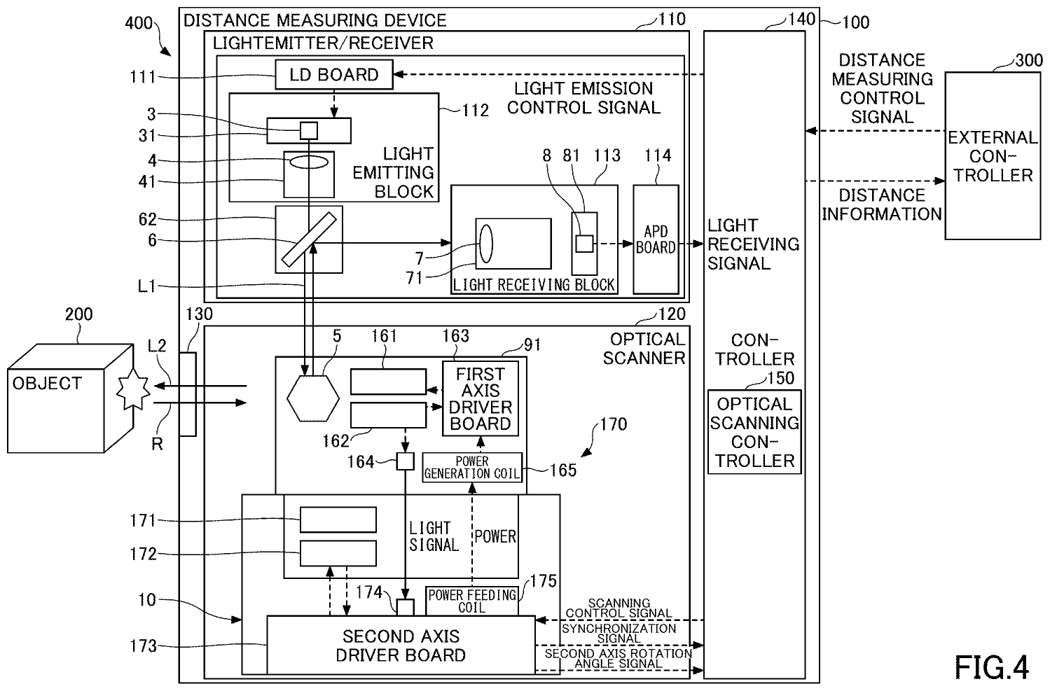

Next, FIG. 4 is a block diagram illustrating an example of the overall configuration of the distance measuring device 100. As for the elements already described with reference to FIGS. 1 to 3, the description are omitted as appropriate. Note that in FIG. 4, a thick solid arrow indicates a flow of light, and a thick dashed arrow indicates a flow of an electric signal.

As illustrated in FIG. 4, the distance measuring device 100 includes a light emitter/receiver 110, an optical scanner 120, an emission window 130, and a controller 140.

The controller 140 electrically connects itself to the external controller 300, the light emitter/receiver 110, and the optical scanner 120, and is capable of transmitting and receiving signals and data with each other. The controller 140 also includes an optical scanning controller 150 that controls the optical scanner 120.

The controller 140 includes a control circuit board having an electric circuit, an electronic circuit, or the like, and is installed, for example, in the rear panel 22 or the like (see FIG. 1). Therefore, even when the polygon mirror 5 and the rotating stage 10 are rotated, the control circuit board as a part of the controller 140 does not move.

The external controller 300 is a controller to control the service robot, and is constituted with with a board PC (Personal Computer) having an ROS (Robot Operating System) installed, and the like.

The light emitter/receiver 110 includes an LD board 111, a light emitting block 112, the holed mirror 6, a holed mirror holder 62, a light receiving block 113, and a APD board 114.

The LD board 111 includes an electric circuit that causes the LD 3 to emit light in response to a light emission control signal from the controller 140.

The light emitting block 112 includes the LD 3, a LD holder 31, the collimating lens 4, and a collimating lens holder 41. The LD holder 31 is a member to hold the LD 3. The collimating lens holder 41 is a member to hold the collimating lens 4. The holed mirror holder 62 is a member to hold the holed mirror 6.

The light receiving block 113 includes the light receiving lens 7, a light receiving lens holder 71, the APD 8, and a APD holder 81. The light receiving lens holder 71 is a member to hold the light receiving lens 7. The APD holder 81 is a member to hold the APD 8.

The APD board 114 includes an electric circuit to output a light receiving signal as an electric signal that corresponds to the intensity of light received by the APD 8, to the controller 140.

The optical scanner 120 includes a board 91 and the rotating stage 10. The board 91 is provided with the polygon mirror 5, a first axis motor 161, a first axis encoder 162, a first axis driver board 163, a synchronization detection LED 164, and a power generation coil 165. Also, the rotating stage 10 is provided with a second axis motor 171, a second axis encoder 172, a second axis driver board 173, a synchronization detection PD 174, and a power feeding coil 175.

A pair of the power generation coil 165 and the power feeding coil 175 constitutes a power feeder 170. The power feeder 170 can execute non-contact power feeding to the first axis motor 161 and the like by electromagnetic induction. Note that power feeding means to feed electric power.

The first axis motor 161 is an example of a rotation driver to rotate the polygon mirror 5. A DC (Direct Current) motor, an AC (Alternating Current) motor, or the like can be used as the first axis motor 161.

The first axis encoder 162 is a rotary encoder, and is an example of a detector to detect the rotation angle of the polygon mirror 5.

The first axis driver board 163 is a board that includes an electric circuit and the like to supply a drive signal to the first axis motor 161. Based on a detection signal supplied by the first axis encoder 162, the first axis driver board 163 can control the polygon mirror 5 to rotate at a predetermined number of rotations per unit time.

Here, the number of rotations per unit time of the polygon mirror 5 is controlled by the first axis driver board 163, and not by the optical scanning controller 150. In other words, the number of rotations per unit time of the polygon mirror 5 is not a control target of the optical scanning controller 150. However, the start and stop of rotation of the polygon mirror 5 is executed based on a scanning control signal from the optical scanning controller 150. Note that the control of the number of rotations can also be rephrased as the control of the rotational speed.

The synchronization detection LED 164 is an example of a synchronous outputter that outputs a synchronization signal synchronized with the rotation of the polygon mirror 5, based on the rotation angle of the polygon mirror 5.

Specifically, the synchronization detection LED 164 emits pulsed light, based on a detection signal of the rotation angle of the polygon mirror 5 detected by the first axis encoder 162. The pulsed light emitted by the synchronization detection LED 164 corresponds to the synchronization signal synchronized with the rotation of the polygon mirror 5, and the synchronization detection LED 164 can output a synchronization signal by emitting pulsed light.

The power generation coil 165 is a coil that generates counter electromotive force by electromagnetic induction, to feed power to the first axis motor 161, the first axis encoder 162, and the first axis driver board 163.

The second axis motor 171 is a motor to rotate the rotating stage 10. As the second axis motor 171, various types of motors such as a DC motor, an AC motor, a stepping motor, or the like can be used. The second axis encoder 172 is a rotary encoder to detect the rotation angle of the rotating stage 10.

The second axis driver board 173 is a board that includes an electric circuit and the like to supply a drive signal to the second axis motor 171. The second axis driver board 173 rotates the rotating stage 10, based on a scanning control signal from the optical scanning controller 150.

Also, the second axis driver board 173 feeds back the rotation angle of the rotating stage 10 detected by the second axis encoder 172, as a second axis rotation angle signal, to the optical scanning controller 150. The optical scanning controller 150 can control the rotating stage 10, based on the second axis rotation angle signal.

Here, the number of rotations per unit time of the rotating stage 10 is controlled by the optical scanning controller 150, and is a control target of the optical scanning controller 150.

The synchronization detection PD 174 outputs a light receiving signal generated in response to receiving pulsed light emitted by the synchronization detection LED 164, to the second axis driver board 173. For example, the synchronization detection LED 164 emits the pulsed light at a timing when the first axis encoder 162 detects an angle corresponding to the rotational origin of the polygon mirror 5.

By receiving the pulsed light emitted by the synchronization detection LED 164, the synchronization detection the PD 174 detects a synchronization timing with respect to the rotation of the polygon mirror 5. Based on an input signal from the synchronization detection the PD 174, the second axis driver board 173 outputs a synchronization signal that indicates the synchronization timing with respect to the rotation of the polygon mirror 5, to the controller 140.

The power feeding coil 175 is a coil that is arranged opposite to the power generation coil 165, and generates counter electromotive force in the power generation coil 165 by electromagnetic induction, in response to an electric current flowing from the second axis driver board 173.

For example, when an electric current flows through the power feeding coil 175, the counter electromotive force is generated in the power generation coil 165 without contact by electromagnetic induction. The power generation coil 165 can feed the generated counter electromotive force as electric power to the first axis motor 161, the first axis encoder 162, and the first axis driver board 163.

Note that in the present embodiment, although a configuration is exemplified in which the power feeder 170 executes non-contact power feeding by electromagnetic induction, the configuration is not limited as such. For example, the power feeder 170 can also feed power through a rotating contact. Here, the rotating contact means an element that is electrically connected to a rotating body through a metal ring and a brush arranged in the rotating body. By using such a rotating contact, power feeding to the first axis motor 161 and the like can be executed from an external source.

As illustrated in FIG. 4, the controller 140 outputs a light emission control signal in response to a distance measuring control signal from the external controller 300, to cause the LD 3 to emit light via the LD board 111. The laser light Ll emitted by the LD 3 and collimated by the collimating lens 4, is then reflected on the reflective surface 51 of the polygon mirror 5, transmits through the emission window 130, and is emitted from the distance measuring device 100 to the outside as the scanning laser light L2.

The emission window 130 is formed to include a glass material or a resin material that has optical transparency with respect to the wavelength of the laser light emitted by the LD 3. In the case where the distance measuring device 100 is provided with an opaque exterior cover that covers the entire device, the emission window 130 serves as a member that functions as a window through which the scanning laser light L2 transmits to be emitted.

The returning light R as the scanning laser light L2 being reflected or scattered on the object 200, transmits through the emission window 130, and is incident on the reflective surface 51 of the polygon mirror 5. Then, the returning light R is reflected on the reflective surface 51, and reflected by the holed mirror 6 toward the APD 8.

The light reflected on the holed mirror 6 is incident on the APD 8 while being collected by the light receiving lens 7. A light receiving signal generated by the APD 8 in response to receiving this incident light is output to the controller 140 through the APD board 114. Based on the light receiving signal, the controller 140 can obtain distance information representing the distance to the object 200 by calculation, and output this distance information to the external controller 300.

Here, in FIG. 4, the light scanning device 400 provided in the distance measuring device 100 includes the LD 3 (a light emitter), the optical scanner 120, the APD 8 (a light receiver), and the optical scanning controller 150.

Also, the distance measuring device 100 can be operated by power fed from a battery installed in the service robot. However, the power feeding is not limited as such; the power may be fed from a battery installed in the distance measuring device 100 itself, or in the case where the operation range of the service robot is not wide, the power may be fed from a commercial power supply by using a cable.

### <Example of Functional Configuration of Controller 140>

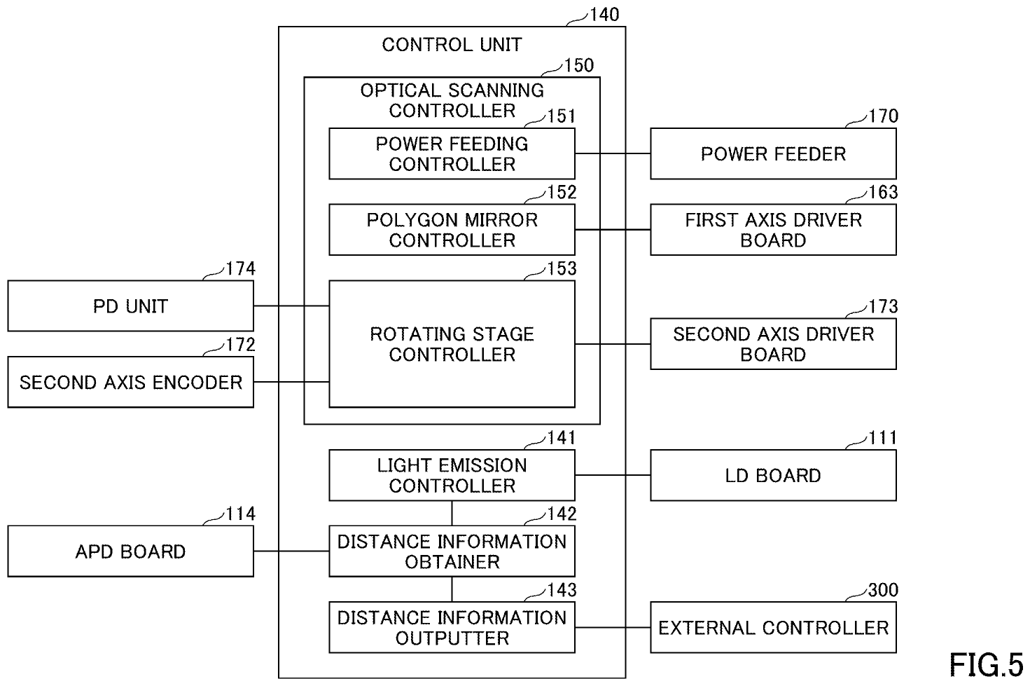

Next, with reference to FIG. 5, a functional configuration of the controller 140 held in the distance measuring device 100 will be described. FIG. 5 is a block diagram illustrating an example of a functional configuration of the controller 140.

As illustrated in FIG. 5, the controller 140 includes the optical scanning controller 150, a light emission controller 141, a distance information obtainer 142, and a distance information outputter 143. The optical scanning controller 150 also includes a power feeding controller 151, a polygon mirror controller 152, and a rotating stage controller 153.

These functional units may be implemented as electric circuits, or some of these functional units may be implemented by software (running on a CPU (Central Processing Unit)). Alternatively, these functional units may implement by multiple circuits or multiple software components.

The power feeding controller 151 controls start and stop of power feeding executed by the power feeder 170. The polygon mirror controller 152 controls start and stop of rotation of the polygon mirror 5 through the first axis driver board 163.

The rotating stage controller 153 receives as input a synchronization signal output by the synchronization detection PD 174 and a second axis rotation angle signal output by the second axis encoder 172, and based on these signals, controls the rotation of the rotating stage 10 through the second axis driver board 173.

The light emission controller 141 controls light emission executed by the LD 3 through the LD board 111. Also, the light emission controller 141 provides the distance information obtainer 142 with information representing the time when the light was emitted by the LD 3.

The distance information obtainer 142 obtains the information on the distance to the object 200, based on the returning light R as the scanning laser light L2 emitted by the light scanning device 400, and being reflected or scattered on the object 200.

Specifically, the distance information obtainer 142 obtains the distance information based on a time difference between a time when the light to be emitted on the object 200 side was emitted by the LD 3, and a time when the returning light R was received by the APD 8 received as input through the APD board 114, by the TOF (Time Of Flight) method.

However, it is not limited as such. The distance measuring device 100 may also use a phase difference detection method or the like that emits an amplitude-modulated laser light, to obtain the distance information based on a phase difference between returning light being reflected or scattered on the object and the emitted laser light.

The distance information obtainer 142 can output the distance information to the external controller 300 via the distance information outputter 143.

### <Example of Operations of Distance Measuring Device 100>

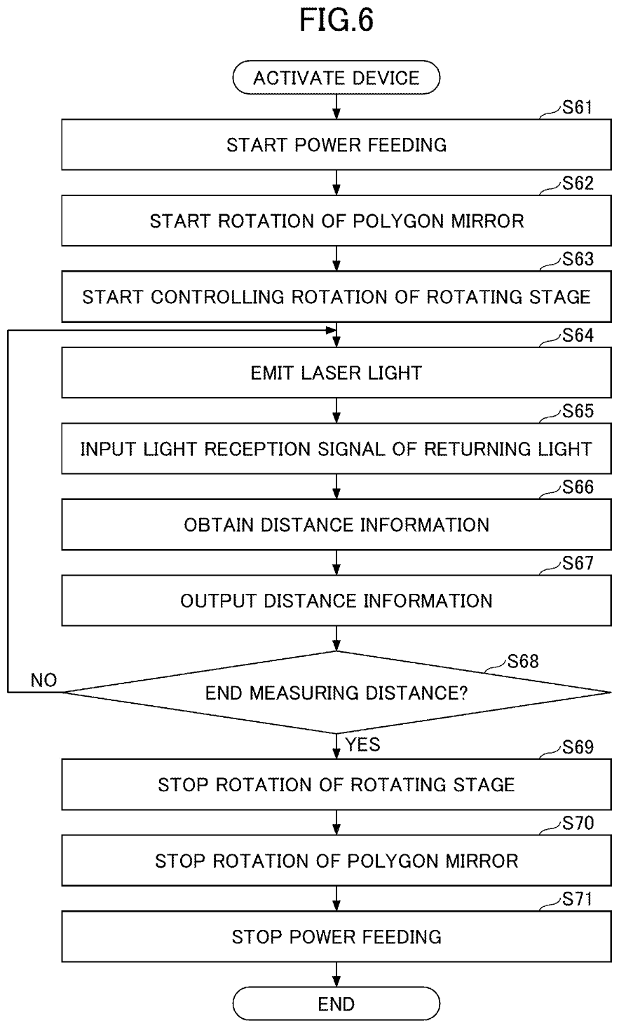

Next, operations of the distance measuring device 100 will be described. FIG. 6 is a flowchart illustrating an example of operations of the distance measuring device 100. Note that FIG. 6 illustrates operations triggered at a point of time when the distance measuring device 100 is activated.

When the distance measuring device 100 is activated, first, at Step S61, the power feeding controller 151 causes the power feeder 170 to start power feeding. feeding.

Next, at Step S62, the polygon mirror controller 152 starts rotation of the polygon mirror 5 through the first axis driver board 163.

Next, at Step S63, the rotating stage controller 153 starts receiving as input the synchronization signal from the synchronization detection PD 174, and starts receiving as input the second axis rotation angle signal from the second axis encoder. Then, the rotating stage controller 153 starts controlling the rotating stage 10 through the second axis driver board 173, based on the synchronization signal and the second axis rotation angle signal.

Next, at Step S64, the light emission controller 141 causes the LD 3 to emit laser light through the LD board 111.

Next, at Step S65, the distance information obtainer 142 receives as input the light receiving signal by the APD 8 through the APD board 114.

Next, at Step S66, the distance information obtainer 142 obtains the distance information to the object 200, based on a time when the light to be emitted on the object 200 side was emitted by the LD 3, and a time when the returning light R was received by the APD 8.

Next, at Step S67, the distance information obtainer 142 outputs the distance information to the external controller 300 via the distance information outputter 143.

Next, at Step S68, the controller 140 determines whether to end the distance measuring.

If it is determined to end at Step S68, the process proceeds to Step S69. On the other hand, if it is determined not to end, the operations at Step S64 and thereafter are executed again.

Next, at Step S69, the rotating stage controller 153 stops the rotation of the rotating stage 10 through the second axis driver board 173.

Next, at Step S70, the polygon mirror controller 152 stops the rotation of the polygon mirror 5 through the first axis driver board 163.

Next, at Step S71, the power feeding controller 151 stops power feeding to the power feeder 170.

In this way, the distance measuring device 100 is capable of causing the scanning laser light L2 to scan, so as to execute distance measuring using the returning light by the object 200.

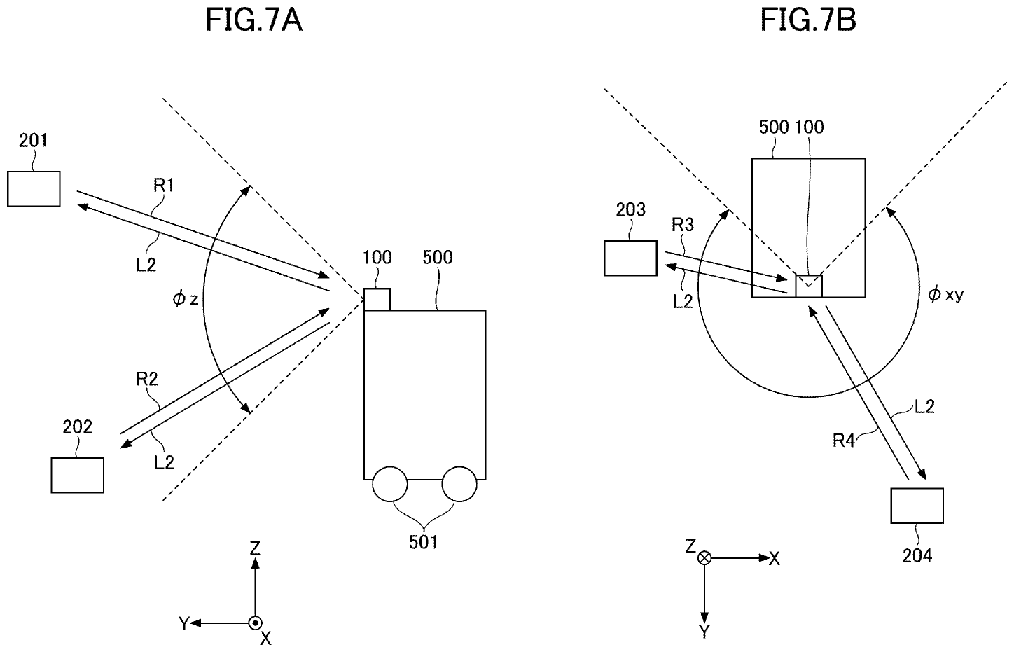

Next, FIG. 7 is a diagram illustrating an example of optical scanning by the distance measuring device 100. FIG. 7A is a side view of the distance measuring device 100; and FIG. 7B is a top view of the distance measuring device 100. FIG. 7 illustrates how the distance measuring device 100 installed in the service robot 500 causes the laser light to scan.

As illustrated in FIG. 7, a service robot 500 is a mobile body having tires 501, and configured to be movable on a path such as a road or a floor. The distance measuring device 100 is fixed on a surface on the +Z direction side of the housing of the service robot 500, and moves together with the service robot 500.

As illustrated in FIG. 7A, the distance measuring device 100 causes the scanning laser light L2 to scan over a scanning angle range cpz around the X-axis corresponding to the first axis A1. Returning light R1 as the scanning laser light L2 being reflected or scattered on an object 201 present within the scanning angle range cpz, returns to the distance measuring device 100, to be received by the APD 8. Similarly, returning light R2 as the scanning laser light L2 being reflected or scattered on an object 202 present within the scanning angle range cpz, returns to the distance measuring device 100, to be received by the APD 8.

Also, as illustrated in FIG. 7B, the distance measuring device 100 causes the scanning laser light L2 to scan over a scanning angle range cpxy around the Z-axis corresponding to the second axis A2. Returning light R3 as the scanning laser light L2 being reflected or scattered on an object 203 present within the scanning angle range cpxy, returns to the distance measuring device 100, to be received by the APD 8. Similarly, returning light R4 as the scanning laser light L2 being reflected or scattered on an object 204 present within the scanning angle range ϕxy, returns to the distance measuring device 100, to be received by the APD 8.

### <Examples of Trajectories of Scanning Lines>

Next, trajectories of scanning lines traced by the scanning laser light L2 emitted from the distance measuring device 100 will be described. Note that a scanning line in the terms of the present embodiment refers to a linear pattern drawn by the tip of the scanning laser light L2 in the propagating direction upon scanning of the scanning laser light L2.

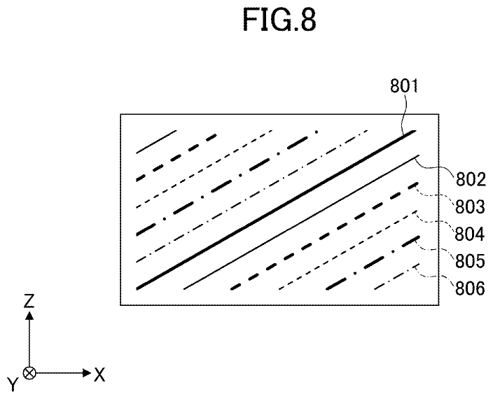

FIG. 8 is a diagram illustrating an example of a scanning line by the distance measuring device 100.

Here, in the present embodiment, the rotating stage controller 153 controls the rotating stage 10 so as to make the number of rotations per unit time of the rotating stage 10 greater than the number of rotations per unit time of the polygon mirror 5. Also, the rotating stage controller 153 controls the rotating stage 10 such that a quotient obtained by dividing a product of the number of rotations per unit time of the polygon mirror 5 and the number of faces of the reflective surfaces 51 included in the polygon mirror 5, by the number of rotations per unit time of the rotating stage 10, to be a non-integer.

In the present embodiment, it is assumed that the number of rotations per unit time of the rotating stage 10 is 1200 rpm, and the number of rotations per unit time of the polygon mirror 5 is 180 rpm.

Also, in the present embodiment, a configuration is adopted in which the number of rotations per unit time of the rotating stage 10 is greater than the number of rotations per unit time of the polygon mirror 5, the number of rotations per unit time of the polygon mirror 5 may be greater than the number of rotations per unit time of the rotating stage 10.

In other words, the rotating stage controller 153 determines the number of rotations per unit time of the rotating stage 10 such that division of a product of the number of rotations per unit time of the polygon mirror 5 and the number of faces of the reflective surfaces 51 included in the polygon mirror 5, by the number of rotations per unit time of the rotating stage 10, to be indivisible (a remainder is generated).

In this way, every time the rotating stage 10 makes one turn around the second axis A2, the position of the scanning line around the second axis A2 in the direction along the second axis A2 (e.g., the Z-axis direction in FIG. 8) can be shifted. By drawing the scanning line multiple times around the second axis A2 while shifting the position in the Z-axis direction, the scanning line can be drawn on the entirety of a plane having a predetermined area that includes, for example, the Z-axis direction and a direction perpendicular to the Z-axis (e.g., the X-axis direction in FIG. 8).

In FIG. 8, the scanning line 801 to 806 indicates scanning lines each of which is drawn upon one turn of the rotating stage 10 around the second axis A2. The scanning line 801 illustrates a scanning line of the first turn; the scanning line 802 illustrates a scanning line of the second turn; the scanning line 803 illustrates a scanning line of the third turn; the scanning line 804 illustrates a scanning line of the fourth turn; the scanning line 805 illustrates a scanning line of the fifth turn; and the scanning line 806 illustrates a scanning line of the sixth turn.

Every time the rotating stage 10 makes one turn, the position of the scanning line around the second axis A2 is shifted in the Z-axis direction.

In the example in FIG. 8, a scanning line upon the seventh turn returns to the original position to overlap the scanning line 801, a scanning line upon the eighth turn similarly overlaps the scanning line 802, and so on.

The polygon mirror 5 rotates in parallel with the rotation of the rotating stage 10;

therefore, each scanning line is tilted as illustrated in FIG. 8. Also, the number of rotations per unit time of the rotating stage 10 is greater than the number of rotations per unit time of the polygon mirror 5; therefore, compared to the tilt of the scanning line with respect to the Z-axis, the tilt with respect to the X-axis is smaller.

In the case where the number of rotations per unit time of the polygon mirror 5 is greater than the number of rotations per unit time of the rotating stage 10, the tilt with respect to the Z-axis is smaller compared to the tilt of the scanning line with respect to the X-axis.

A cycle of the scanning line returning to the original position, and the tilt of the scanning line can be determined by the ratio of the number of rotations per unit time of the rotating stage 10 to the number of rotations per unit time of the polygon mirror 5. In other words, the optical scanning controller 150 can determine and control the number of rotations per unit time of the rotating stage 10 so that a predetermined ratio to the number of rotations per unit time of the polygon mirror 5 is obtained.

Note that in the case where the number of rotations per unit time of the polygon mirror 5 is sufficiently greater than the number of rotations per unit time of the rotating stage 10, and a sufficient number of the scanning line can be drawn by rotation of the polygon mirror 5 while the rotating stage stage 10 makes one turn, control may be executed so as not to shift the position of the scanning line in the Z-axis direction for each turn. Even under this control, the scanning line can be drawn on the entire plane having the predetermined area including the Z-axis direction and the X-axis direction.

In this case, the rotating stage controller 153 controls the rotating stage 10 so as to have a quotient obtained by dividing a product of the number of rotations per unit time of the polygon mirror 5 and the number of faces of the reflective surfaces 51 included in the polygon mirror 5, by the number of rotations per unit time of the rotating stage 10, to be an integer, namely, to be divisible (a remainder is not generated). In this way, every time the rotating stage 10 makes one turn around the second axis A2, the position of the scanning line around the second axis A2 is not shifted in the Z-axis direction.

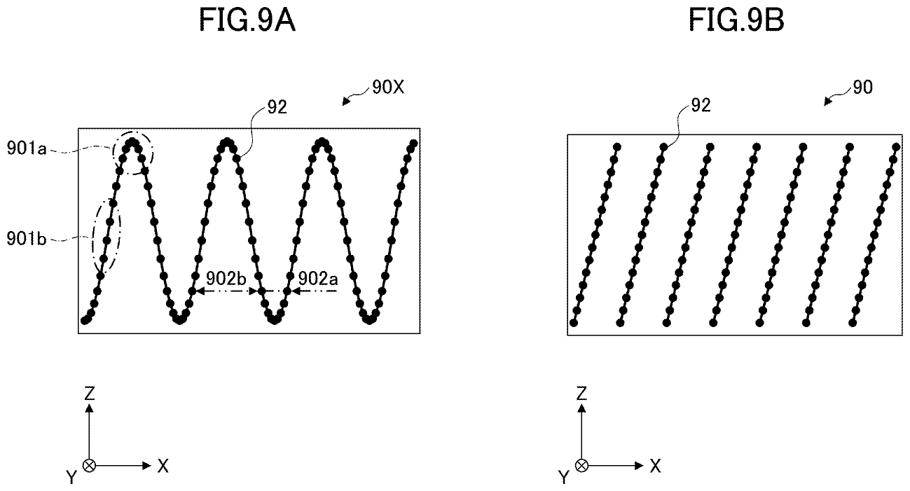

Next, FIG. 9 illustrates other examples of trajectories of scanning lines. FIG. 9A illustrates a comparative example; and FIG. 9B illustrates the present embodiment. Circular plots in graphs in FIGS. 9A and 9A mean beam spots 92 of the scanning laser light L2. The beam spots 92 are scanned and the scanning line is drawn according to the scanning of the scanning laser light L2.

The comparative example illustrates a scanning line 90X in a configuration in which the laser light is caused to scan back and forth around the second axis A2 by a swing mirror. The swing mirror swings back and forth according to a sinusoidal drive waveform. In the case of using a sinusoidal drive waveform, the swing speed of the swing mirror is not constant; therefore, the spacing between adjacent beam spots in the trajectory of the scanning laser light L2 varies to be sparser or denser.

A region 901a on the scanning line 90X indicates an area where the spacing of the beam spots in the Z-axis direction is denser, and a region 901b indicates an area where the spacing of the beam spots in the Z-axis direction is sparser.

Also, a region 902a indicates an area where the spacing of the beam spots in the X-axis direction is denser, and a region 902b indicates an area where the spacing of the beam spots in the X-axis direction is sparser. As illustrated in FIG. 9A, optical scanning with a swing mirror generates sparser or denser portions of the beam spots.

If the distance measuring device generates sparser or denser portions of the beam spot, it is undesirable because the spatial resolution varies for individual measurement areas of the distance. In order to eliminate sparser or denser portions of the beam spots, at least one of the emission timing of the light emitter or the swing speed of the swing mirror needs to be varied for individual measurement areas, and hence, the control becomes complicated.

Also, in the case of executing optical scanning in both the outward and returning paths in the back and forth swinging, positions in the X-axis direction to emit light to beam spots differ in the outward and returning paths depending on the position in the Z-axis direction. In this way, the sparser or denser portions of the beam spots are generated, and thereby, even more complicated control is required to eliminate the sparser or denser portions of the beam spot.

In contrast, in the present embodiment, when the polygon mirror 5 is rotated around the second axis A2 at a substantially constant speed, by causing the polygon mirror 5 to rotate at a substantially constant speed, raster scanning can be executed with the scanning laser light L2. As illustrated in FIG. 9B, the spacing between the beam spots 92 forming the scanning line 90 is substantially constant, and the spacing between the scanning line 90 along the X-axis direction is also substantially constant. In this way, in the present embodiment, there is no sparser or denser spacing between the beam spots 92. Therefore, the complex control to eliminate sparser or denser spacing between the beam spots 92 are also unnecessary.

### <Effects of Distance Measuring Device 100>

Next, effects of the distance measuring device 100 will be described. Note that although the effects of the distance measuring device 100 will be described below, the term of “the distance measuring device 100” may be replaced with the term of “the light scanning device 400”, and the effects can also be stated as the effects of the light scanning device 400.

In recent years, the development and introduction of autonomous mobile service robot is in progress, primarily the purpose of services such as transportation of materials in a factory, transportation of merchandise and information services in a customer service facility, on-site security, cleaning, and the like. Also, in order to detect an object in the traveling direction of such a service robot or around the service robot, or create an in-house map of a facility where the service robot is operating, distance measuring devices such as LiDAR devices are used often.

As the distance measuring device, a two-dimensional distance measuring device has been known that measures the distance to an object present in a plane, for example, by causing light to scan in a plane crossing in the direction of gravity. Also, a three-dimensional distance measuring device has been known that measures the distance to an object present in a three-dimensional space, by causing the light to scan in the direction of gravity, in addition in the plane crossing in the direction of gravity.

Although the three-dimensional distance measuring device is favorable for detecting an object present in a three-dimensionally large range to measure the distance, as the negative aspects, the structure and control of the device become complicated, and thereby, the device becomes expensive. For example, the price of the three-dimensional distance measuring device is assumed to be 20 to 30 times higher than that of the two-dimensional distance measuring device. The complexity of the structure and control of the device, as well as the cost of the device, can be the constraints when installing the distance measuring device in a relatively inexpensive service robot from among commercially available robots.

Also, as for the three-dimensional distance measuring device, a configuration is disclosed that includes a movable part that is swingable around the first axis center; a first deflection mechanism provided with a driver that drives the movable part to swing; a second deflection mechanism that drives the first deflection mechanism to rotate around a second axis center that is different from the first axis center; a light deflector installed in the movable part to reflect and deflect measurement light emitted from a light projector/receiver along the second axis center; and a swing controller that controls the driver described above (see, for example, Patent Document 1).

However, in the configuration disclosed in Patent Document 1, a movable part is swung back and forth to cause light to scan; therefore, a complex control is required for control of suppressing fluctuation of the swing speed of the movable part. In the case of resonantly driving the movable part, control of the resonant frequency is also required, and thereby, the control becomes further complicated. Also, if widening the scanning angle range of the optical scanning, more sophisticated control such as control for taking into account the deformation of the movable part becomes required.

Also, in the case of driving the movable part according to a serrated drive waveform for executing raster scanning of light by a swinging movable part, it becomes necessary to provide a storage device to store the serrated drive waveform and a control device to suppress unnecessary resonance, and thereby, the complexity of the control and the cost of the device further increase.

In contrast, in the present embodiment, the optical scanner 120 included in the distance measuring device 100 includes the polygon mirror 5 (a rotating polyhedron) that includes the multiple reflective surfaces 51, and causes the laser light to scan around the first axis A1 by reflecting the laser light emitted by the LD 3 (a light emitter) on the reflective surface 51 while rotating around the first axis A1. Also, the optical scanner 120 includes the angle plate 9 (a supporter) configured to support the polygon mirror 5, and the rotating stage 10 (a rotating mechanism) configured to cause the laser light reflected on the reflective surface 51 of the polygon mirror 5 to scan around the second axis A2 by rotating the angle plate 9 around the second axis A2.

Each of the polygon mirror 5 and the rotating stage 10 rotates continuously in a predetermined direction of rotation; therefore, it is not necessary to execute complex control such as control of suppressing fluctuation of the swing rate of the movable part, control of the resonant frequency, and the like. In this way, a light scanning device in which the control can be simplified, can be provided. Also, by simplifying the control, the control circuit board can be made smaller, and the cost of the distance measuring device 100 can be reduced.

Further, by adopting the optical scanning by rotation, the scanning angle range of the optical scanning can be easily widened. In the case where the scanning angle range of the optical scanning is narrow, in order to secure the desired scanning angle range, one may consider adopting a configuration in which multiple pairs of light emitter and light receiver are provided. However, if providing multiple pairs of light emitter and light receiver, the cost is increased for the additional pairs, and the configuration of the distance measuring device 100 becomes complicated. In the present embodiment, by adopting the optical scanning by rotation, such an increase in the cost and complexity of the configuration can be prevented.

Also, by rotating the polygon mirror 5 at a substantially constant speed while rotating the rotating stage 10 at a substantially constant speed, raster scanning with laser light can be easily executed at a constant speed. In this way, the spacing between the beam spots of the laser light to be scanned can be kept substantially constant by the simple control, and the spatial resolution of individual measurements area can be made uniform.

Also, in the present embodiment, the optical scanning controller 150 does not set the number of rotations per unit time of the polygon mirror 5 as a control target.

Here, the polygon mirror 5 is rotated around the second axis A2 as the angle plate 9 rotates by the rotating stage 10. If the control circuit board included in the optical scanning controller 150 is connected with wiring for controlling the polygon mirror 5, the wiring rotates or moves together with the rotation of the polygon mirror 5 around the second axis A2, and hence, consideration is required for the rotation or movement with respect to the wiring.

Even if the control circuit board is provided on the rotating stage 10, wiring connecting the external controller 300 or the like with the control circuit board is required, and consideration is required for the rotation or movement with respect to the wiring and the like together with the rotation of the polygon mirror 5 around the second axis A2.

By not setting the number of rotations per unit time of the polygon mirror 5 as a control target, the wiring connecting the optical scanning controller 150 with the polygon mirror 5 for controlling the polygon mirror 5 becomes unnecessary. As a result, consideration becomes unnecessary for the rotation or movement of the wiring and the like together accompanying the rotation of the polygon mirror 5 around the second axis A2, and hence, the configuration of the distance measuring device 100 can be further simplified.

Also, the polygon mirror 5 rotates in the direction of rotation at a substantially constant number of rotations; therefore, complex control is not required. In this way, the simplified control circuit provided on the first axis driver board 163 provided on the rotating stage 10 can be used for controlling the number of rotations per unit time of the polygon mirror 5, and the optical scanning controller 150 can avoid setting the number of rotations per unit time of the polygon mirror 5 as a control target.

Also, in the present embodiment, the distance measuring device 100 includes the base plate 1 (a base) and the holder 2, and the holder 2 and the rotating stage 10 are arranged in different areas on the base plate 1. In this way, even when the rotating stage 10 rotates, the holder 2, and the LD 3 and APD 8 (a light receiver) held by the holder 2 do not move, and the state of being fixed to the base plate 1 is maintained.

For example, if adopting a configuration in which the LD 3 and the APD 8 are rotated by the rotating stage 10, consideration is required for the rotation or movement of the wiring and the like to control the LD 3 and the APD 8 together with the rotation of the LD 3 and the APD 8.

In contrast, by having the LD 3 and the APD 8 as immobile elements even when the rotating stage 10 rotates, consideration becomes unnecessary for the rotation or movement of the wiring and the like, and thereby, the configuration of the distance measuring device 100 can be simplified. Also, compared to a configuration in which the LD 3 and the APD 8 are rotated by the rotating stage 10, the traffic volume of communication of data between the LD 3 and the APD 8, and the controller 140 can be reduced, and thanks to the reduced traffic volume of communication of data, the cost of the distance measuring device 100 can be reduced.

Note that in the present embodiment, although a configuration is exemplified in which the base plate 1 is separated from the holder 2, and the holder 2 is fixed to the base plate 1, the configuration is not limited as such. For example, a configuration may be adopted in which the base plate 1 and the holder 2 are formed to be unified.

Also, although a configuration is exemplified in which the holder 2 includes the ceiling panel 21 and the rear panel 22, the configuration is not limited as such. For example, the holder holder 2 may be configured as a single member in which the ceiling panel 21, the rear panel 22, and the like are unified.

Also, although a configuration is exemplified in which the ceiling panel 21 holds the LD 3, and the rear panel 22 holds the APD 8, the configuration is not limited as such. For example, a configuration may be adopted in which either one of the ceiling panel 21 or the rear panel 22 holds both the LD 3 and the APD 8.

Here, in the case where the distance measuring device 100 is not provided with an exterior cover, the rotating stage 10 can cause the laser light to scan more widely around the second axis A2. However, in the scanning angle range around the second axis A2 in accordance with the size of the rear panel 22, the scanning laser light L2 is blocked by the rear panel 22, and the scanning laser light L2 cannot be emitted. In other words, the scanning angle range around the second axis A2 in accordance with the size of the rear panel 22 becomes a blind spot range within which object detection and distance measuring cannot be executed.

Therefore, a structure may be provided in place of the rear panel 22 or the rear panel 22 on the −Y direction side of the rotating stage 10, to have a size along the circumferential direction around the second axis A2 as small as possible; this is favorable because the blind spot range described above can be made narrower.

For example, a configuration is adopted in which the light receiving lens 7, the APD 8, the controller 140, and the like are fixed to the ceiling panel 21, and a pillar to support the ceiling panel 21 instead of the rear panel 22 is provided in the holder 2. In this configuration, the blind spot range is only a scanning angle range corresponding to the thickness of the pillar, and thereby, the blind spot range becomes even smaller. In this way, the object detection and distance measuring can be executed in a wider scanning angle range around the second axis A2.

Also, in the present embodiment, the scanning laser light L2 (scanning light) reflected on one of the multiple reflective surfaces 51 included in the polygon mirror 5, is reflected or scattered on the object 200, and then, the APD 8 receives the returning light R reflected again on the one surface described above. This configuration increases the number of optical paths that are common between the optical paths of the laser light L1 and the scanning laser light L2, and the optical paths of the returning light R. As a result, compared to the case where these paths are provided separately, the configuration of the distance measuring device 100 can be simplified.

Also, in the present embodiment, the distance measuring device 100 includes the holed mirror 6 (a light deflector) that deflects the returning light R as the scanning laser light L2 being reflected or scattered on the object 200, and the holed mirror 6 includes the through hole 61 (an opening portion) through which the laser light L1 emitted by the LD 3 passes.

This configuration increases the number of optical paths that are common between the optical paths of the laser light L1 and the optical paths of the returning light R, and hence, the configuration of the distance measuring device 100 can be simplified. Also, the through hole 61 transmits the laser light L1 emitted by the LD 3; therefore, compared to the case where the laser light is transmitted by using a beam splitter or the like, the through hole 61 can prevent a decrease in light utilization efficiency or stray light due to multiple reflections or the like on the light transmitting surface, and thereby, the measurement accuracy is further improved.

Also, in the present embodiment, the laser light L1 emitted by the LD 3 is incident on the reflective surface 51 of the polygon mirror 5 along the second axis A2. For example, the optical axis of the laser light L1 is configured to be coaxial with the second axis A2.

This configuration prevents the position of the laser light L1 incident on the reflective surface 51 from being changed even when the rotating stage 10 rotates. Therefore, the optical scanning around the first axis A1 and the optical scanning around the second axis A2 can be executed with a simple configuration.

Also, in the present embodiment, the first axis motor 161 (a rotation driver) that rotates the polygon mirror 5 is provided in the rotating stage 10.

Here, for example, if the polygon mirror 5 is coupled with the first axis motor 161 via a coupling member such as a pulley, and the first axis motor 161 is provided in an area other than the rotating stage 10 such as the base plate 1 or the like, consideration becomes required for rotation or movement of the coupling member with respect to the rotation of the rotating stage 10.

In contrast, by providing the first axis motor 161 on the rotating stage 10, such consideration for rotation or movement of the coupling member can be eliminated, and hence, the configuration of the distance measuring device 100 can be simplified.

Also, in the present embodiment, the distance measuring device 100 includes the power feeder 170 that feeds power without contact to the first axis motor 161 by electromagnetic induction. In this way, it is not necessary to connect with wiring for feeding power to the first axis motor 161 and the like, and thereby, consideration becomes unnecessary for the rotation or movement with respect to the wiring and the like together with the rotation of the rotating stage 10 around the second axis A2. As a result, the configuration of the distance measuring device 100 can be simplified.

Also, in the present embodiment, the distance measuring device 100 includes the first axis encoder 162 (a detector) that detects the rotation angle of the polygon mirror 5, and the LED 164 (a synchronous outputter) that emits light corresponding to the synchronization signal synchronized with the rotation of the polygon mirror 5, based on the rotation angle of the polygon mirror 5. The optical scanning controller 150 controls the rotation by the rotating stage 10 based on the light (a synchronization signal) emitted by the LED 164.

By providing the synchronization signal synchronized with the rotation of the polygon mirror 5 to the rotating stage 10 without contact by using pulsed light, connection of wiring to provide the synchronization signal can be eliminated. In this way, consideration can be eliminated for the rotation or movement with respect to the wiring and the like together with the rotation of the rotating stage 10 around the second axis A2. As a result, the configuration of the distance measuring device 100 can be simplified.

However, the synchronous outputter is not limited to the configuration that uses the synchronization detection LED 164. The synchronization signal can be provided from the polygon mirror 5 to the rotating stage 10 by using a rotating contact. Also in this case, the same effects can be obtained as in the case of using the pulsed light.

Also, in the present embodiment, the optical scanning controller 150 controls the number of rotations per unit time of the rotating stage 10 so that a predetermined ratio to the number of rotations per unit time of the polygon mirror 5 is obtained. For example, the optical scanning controller 150 controls a quotient obtained by dividing a product of the number of rotations per unit time of the polygon mirror 5 and the number of faces of the reflective surfaces 51 included in the polygon mirror 5, by the number of rotations per unit time of the rotating stage 10, to be a non-integer.

In this way, every time the rotating stage 10 makes one turn around the second axis A2, the position of the scanning line around the second axis A2 in the direction along the second axis A2 (the Z-axis direction) can be shifted. By drawing the scanning line multiple times around the second axis A2 while shifting the position in the Z-axis direction, the scanning line can be drawn on the entirety of a plane having a predetermined area, for example, including the Z-axis direction and a direction perpendicular to the Z-axis (the X-axis direction), without executing complicated control. In addition, control in the configuration of the distance measuring device 100 can be simplified.

Note that the optical scanning controller 150 can can control the rotating stage 10 so as to make the number of rotations per unit time of the rotating stage 10 greater than the number of rotations per unit time of the polygon mirror 5, or on the contrary, can control so as to make the number of rotations per unit time of the polygon mirror 5 greater than the number of rotations per unit time of the rotating stage 10.

### Second Embodiment

Next, a distance measuring device 100a according to the second embodiment will be described. Note that elements that are the same as those already described in the first embodiment are assigned the same reference signs, and the duplicate description may be omitted as appropriate.

In the present embodiment, the first axis Al is provided along a direction that crosses both the first axis A1 and the second axis A2, and at a position apart from the second axis A2. Also, the position of the polygon mirror 5 is variable along a variable direction B that crosses both the first axis A1 and the second axis A2. When the position of the polygon mirror 5 in the variable direction B changes, an inter-axes distance d along the variable direction B to the position of the first axis A1 apart from the second axis A2 changes, and an angular direction C as the median value of the scanning angle range around the first axis A1 by the polygon mirror 5 changes.

Therefore, by changing the inter-axes distance d and changing the angular direction C according to the direction in which an object 200 is likely to be present in a three-dimensional space, it becomes more easier to detect the object 200.

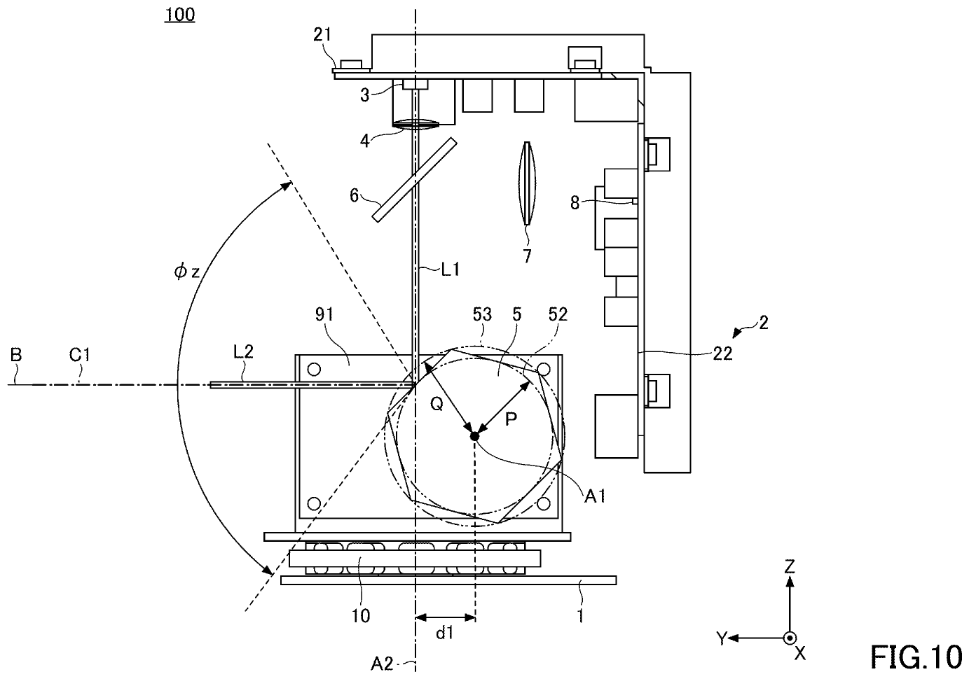

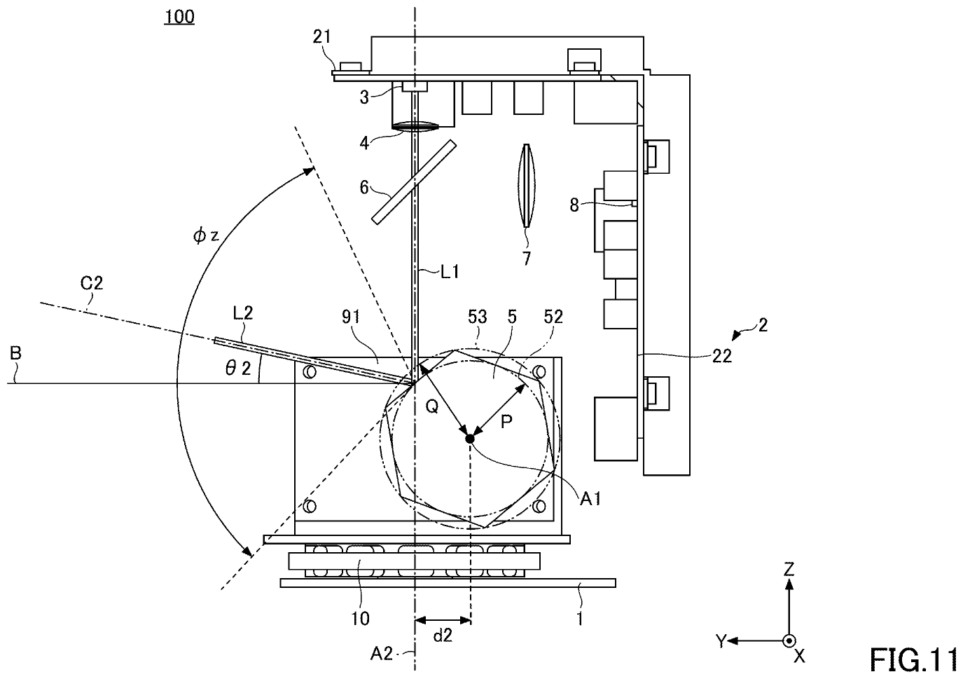

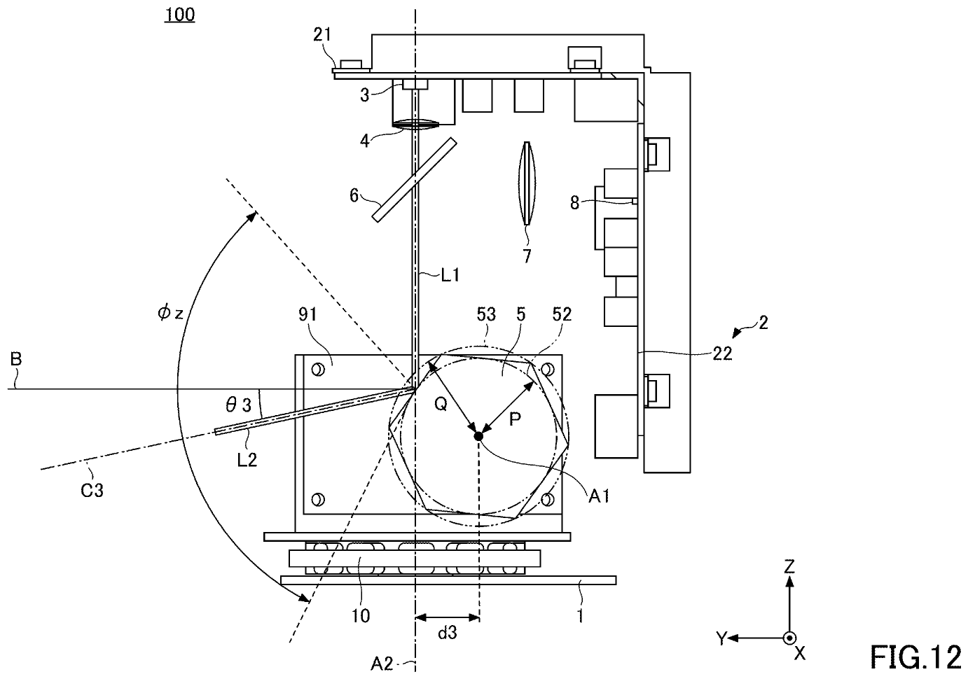

Here, FIGS. 10 to 12 are diagrams each illustrating an example of the inter-axes distance d. FIG. 10 is a diagram illustrating a first example; FIG. 11 is a diagram illustrating a second example; and FIG. 12 is a diagram illustrating a third example.

In the case of using a polygon mirror 5 being a regular polygonal cylinder, the inter-axes distance d is less than or equal to a radius P of the inscribed circle of the regular polygon of the regular polygonal cylinder, and is subject to a condition expressed by Formula (1) shown below:

$$θ = ( {45}^{°} - {sin}^{- 1} \frac{d}{Q} ) \times 2 \qquad ( 1 )$$

In Formula (1), θ represents the angle between the angular direction C and the variable direction B, and Q represents the radius of the circumscribed circle of the regular polygon in the polygon mirror 5.

In FIG. 10, the inter-axes distance d1 represents an inter-axes distance along the variable direction B, to the position of the first axis A1 apart from the second axis A2. P represents the radius of the inscribed circle of the inscribed circle 52, and Q represents the radius of the circumscribed circle of the circumscribed circle 53. The angular direction Cl is a direction along an angle that is the median value of the scanning angle range pz around the first axis A1. An angle el formed between the angular direction Cl and the variable direction B depends on the inter-axes distance d1, which is 0 degrees from Formula (1), and the angular direction Cl is almost coincident with the variable direction B.

Next, in the second example illustrated in FIG. 11, compared to the first example illustrated in FIG. 10, the polygon mirror 5 is moved toward the +Y direction side, and an inter-axes distance d2 is smaller than the inter-axes distance d1. An angle θ2 formed between the angular direction C2 and the variable direction B depends on the inter-axes distance d2, and is an angle tilted to the +Z direction side from Formula (1), and the angular direction C2 is tilted to the +Z direction side with respect to the variable direction B.

In this configuration, the distance measuring device 100a can execute optical scanning around the first axis A1 in the scanning angle range slightly shifted to the +Z direction side compared to the first example, and it becomes easier to detect the object 200 present on the +Z direction side, compared to the first example.

Next, in the third example illustrated in FIG. 12, compared to the first example illustrated in FIG. 10, the polygon mirror 5 is moved toward the −Y direction side, and an inter-axes distance d3 is greater than the inter-axes distance d1. An angle θ3 formed between the angular direction C3 and the variable direction B depends on the inter-axes distance d3, and is an angle tilted to the −Z direction side from Formula (1), and the angular direction C3 is tilted to the −Z direction side with respect to the variable direction B.

In this configuration, the distance measuring device 100a can execute optical scanning around the first axis A1 in the scanning angle range slightly shifted to the −Z direction side compared to the first example, and it becomes easier to detect the object 200 present on the −Z direction side, compared to the first example.

Note that in the distance measuring device 100a, the inter-axes distance d can be set by defining in advance the position of the polygon mirror 5 in the variable direction B.

As described above, in the present embodiment, the first axis A1 is provided along a direction that crosses both the first axis A1 and the second axis A2, and at a position apart from the second axis A2. By selecting an inter-axes distance along the variable direction B to the position of the first axis A1 apart from the second axis A2, the angular direction C can be varied depending on the direction in which an object 200 is likely to be present in a three-dimensional space, and thereby, making it easier to detect the object 200.

Also, in the present embodiment, the inter-axes distance d can also be varied according to the position of the polygon mirror 5 in the variable direction B. The angular direction C changes according to the inter-axes distance d. Therefore, by changing the inter-axes distance d and changing the angular direction C according to the direction in which the object 200 is likely to be present in the three-dimensional space, it becomes more easier to detect the object 200.

Note that the other effects are substantially the same as those described in the first embodiment.

As described above, the embodiments has been described; note that the present inventive concept is not limited to the embodiments specifically disclosed herein, and various variations and alterations can be made without deviating from the subject matters described in the claims.

For example, the mobile body in which the distance measuring device 100 or 100a is installed is not limited to a service robot. For example, the mobile body may be one capable of moving on land such as an automobile, vehicle, electric train, stream train, or forklift; one capable of moving in the air such as an airplane, balloon, or drone; or one capable of moving on the water such as a ship, vessel, steamer, or boat.

Also, although the light that is caused to scan by the light scanning device 400 is exemplified as laser light, it is not limited as such; light without directivity may be used. Also, an electromagnetic wave having a longer wavelength such as radar can also be used as a type of light.

The ordinal numbers, quantities and the like used in the description of an embodiment are all exemplary for the purpose of describing specifically the techniques of the present inventive concept, and the present inventive concept is not limited to these exemplary numbers. Also, the connection relationship between the components is exemplary for purposes of describing the techniques of the present inventive concept, and the present inventive concept is not limited such a connection relationship that implements the functions of the present inventive concept.

Also, partitioning of blocks in a functional block diagram is merely an example, and multiple blocks may be implemented as one block, one block may be divided into multiple blocks, and/or some of the functions of a block may be transferred to the other blocks. Also, the functions of multiple blocks having similar functions may be processed in parallel or in time sharing by a single hardware or software component.

1. A light scanning device comprising:
a light emitter configured to emit light;
an optical scanner configured to cause the light to scan;
a light receiver configured to receive returning light as scanning light from the optical scanner being reflected or scattered on an object; and
an optical scanning controller including processing circuitry configured to control the optical scanner,
wherein the optical scanner includes
a rotating polyhedron configured to include a plurality of reflective surfaces, to cause the light to scan around a first axis by reflecting the light on a reflective surface while rotating around the first axis,
a supporter configured to support the rotating polyhedron, and
a rotating mechanism configured to rotate the supporter around a second axis that crosses the first axis, to cause the light reflected on the reflective surface to scan around the second axis.

2. The light scanning device as claimed in claim 1, wherein the optical scanning controller does not set a number of rotations per unit time of the rotating polyhedron as a control target.

3. The light scanning device as claimed in claim 1, further comprising:
a base; and
a holder configured to hold the light emitter and the light receiver,
wherein the holder and the rotating mechanism are provided in different areas on the base.

4. The light scanning device as claimed in claim 1, wherein the scanning light reflected on one reflective surface from among the plurality of reflective surfaces included in the rotating polyhedron, is reflected or scattered on the object, and then, the light receiver receives the returning light reflected again on the one reflective surface.

5. The light scanning device as claimed in claim 1, further comprising:
a light deflector configured to deflect the returning light,
wherein the light deflector includes an opening portion through which light emitted by the light emitter passes.

6. The light scanning device as claimed in claim 1, wherein the light emitted by the light emitter is incident on the reflective surface of the rotating polyhedron along the second axis.

7. The light scanning device as claimed in claim 1, wherein the first axis is provided in a direction that crosses both the first axis and the second axis, and at a position apart from the second axis.

8. The light scanning device as claimed in claim 7, wherein the rotating polyhedron is a regular polygonal cylinder having the first axis as a central axis, and
wherein an inter-axes distance d to the position of the first axis apart from the second axis is less than or equal to a radius of an inscribed circle of a regular polygon of the regular polygonal cylinder, and is subject to a condition expressed by a formula shown below:
$$θ = ( {45}^{°} - {sin}^{- 1} \frac{d}{Q} ) \times 2 \qquad ( 1 )$$
where θ represents an angle formed between an angular direction as a median value of a scanning angle range around the first axis by the rotating polyhedron, and a direction that crosses both the first axis and the second axis; and Q represents a radius of a circumscribed circle of the regular polygon.

9. The light scanning device as claimed in claim 8, wherein a position of the rotating polyhedron is variable within a range of the inter-axes distance d along a direction crossing both the first axis and the second axis.

10. The light scanning device as claimed in claim 1, wherein a rotation driver configured to rotate the rotating polyhedron, is provided in the rotating mechanism.

11. The light scanning device as claimed in claim 10, further comprising:
a power feeder configured to feed power by electromagnetic induction to the rotation driver without contact or with a rotating contact.

12. The light scanning device as claimed in claim 1, further comprising:
a detector configured to detect a rotation angle of the rotating polyhedron; and
a synchronous outputter configured to output a synchronization signal synchronized with rotation of the rotating polyhedron, based on the rotation angle,
wherein the optical scanning controller controls the rotation by the rotating mechanism, based on the synchronization signal.

13. The light scanning device as claimed in claim 1, wherein the optical scanning controller controls a number of rotations per unit time of the rotating mechanism so that a predetermined ratio to the number of rotations per unit time of the rotating polyhedron is obtained.

14. The light scanning device as claimed in claim 1, wherein a quotient obtained by dividing a product of a number of rotations per unit time of the rotating polyhedron and a number of faces of the reflective surfaces included in the rotating polyhedron, by a number of rotations per unit time of the rotating mechanism takes a non-integer value.

15. A distance measuring device comprising:
the light scanning device as claimed in claim 1; and
an outputter configured to output information on a distance to the object, obtained based on the returning light as the scanning light from the light scanning device being reflected or scattered on the object.
